(19) United States
(12) Patent Application Publication
(10) Pub. No.: US 2025/0015680 A1
(43) Pub. Date: Jan. 9, 2025

(54) Grounding of a Rotor of an Electric Machine

(71) Applicant: ZF Friedrichshafen AG, Friedrichshafen (DE)

(72) Inventors: Stefan Peters, Freidrichshafen (DE); Stefan Ketterer, Friedrichshafen (DE); Michael Griesbach, Tettnang (DE)

(21) Appl. No.: 18/763,249

(22) Filed: Jul. 3, 2024

(30) Foreign Application Priority Data
Jul. 5, 2023 (DE) 102023206355.7

(51) Int. Cl. H02K 11/40; H02K 5/04

(52) U.S. Cl. CPC H02K 11/40; H02K 5/04

(57) ABSTRACT

An electric machine (120) has a housing (225) and a rotor (205), which is mounted in the housing (225) for rotation about a rotational axis (215). In the housing (225), a recess (230) is provided at one axial end of the rotor (205), in which a closure element (235) is removably attached. A grounding contact (280) is arranged axially between the closure element (235) and the rotor (205).

### CROSS-REFERENCE TO RELATED APPLICATION

The present application is related and has right of priority to German Patent Application No. DE 102023206355.7 filed on Jul. 5, 2023, which is incorporated by reference in its entirety for all purposes.

### TECHNICAL FIELD

The present invention relates generally to the grounding of a rotor of an electric machine. In particular, the invention relates generally to the grounding of a rotor of an electric drive motor for a motor vehicle.

### BACKGROUND

A motor vehicle has an electric machine, which can be operated using energy from an electrical energy store in order to propel the motor vehicle. The electric machine has a housing which includes a stator and a rotor. The rotor is mounted for rotation about a rotational axis with respect to the stator and the housing. A grounding contact can be provided in order to prevent a build-up of a difference in electrical potential between the rotor and the housing. The grounding contact has a first side and a second side, which are electrically connected to one another but are separated from one another with respect to a torque. The bearing is mounted on the electric machine such that one side is connected to the rotor and the other side is connected to the housing.

Various approaches have been described for attaching a grounding contact to an electric machine. CN 214 506 818 U describes a grounding contact which is attached to one axial end of a rotor of an electric machine. The grounding contact has a roller bearing between the rotor and the housing, which is axially preloaded by an elastic element.

It has been shown, however, that roller bearings tend to corrode under the effect of an electric current conducted through them. The use of a grounding contact has therefore been proposed, the grounding contact having two elements which are axially pressed together and arranged along the rotational axis. Such a bearing is subjected to a certain amount of wear due to friction, however, and it may be necessary to inspect and, if necessary, replace the contact partner at predetermined intervals. Previously it was necessary, for this purpose, to open the housing of the electric machine in order to access the grounding contact. In particular when the electric machine is accommodated together with other elements in a common housing, performing maintenance on the grounding contact can be time-consuming.

### BRIEF SUMMARY

Example aspects of the present invention provide an improved technique for grounding a rotor of an electric machine.

According to a first example aspect of the present invention, an electric machine has a housing and a rotor, which is mounted in the housing for rotation about a rotational axis. In the housing, a recess is provided at one axial end of the rotor, in which recess a closure element is removably attached. A grounding contact is arranged axially between the closure element and the rotor.

Access to the grounding contact can be facilitated by removing the closure element from the housing. It is not essential to open the housing to perform a service action on the grounding contact. In many applications, it is not essential to remove the housing, including the electric machine, from an enclosing structure. Available installation space can be advantageously utilized for attaching the grounding contact. The closure element can overhang a boundary of the housing only slightly or not at all.

The grounding contact can have a first side and a second side, which are electrically connected to one another but are separated from one another with respect to a torque. It is preferred when the first side and the second side form an abutting electrical contact, which does not have a rolling element. In particular, the first side and the second side can be pressed axially against one another in order to establish electrical contact with as little friction as possible. One side can have a wear-resistant front plate and the other side can have an electrical conductor, which is in the form of a wear part. For example, a carbon pin can be used for this purpose. To compensate for axial mechanical wear, one of the sides can be pressed against the other side by an axially acting, elastic element.

Such a grounding contact can improve the equalization of electrical potential between the rotor and the housing, without risking electrical corrosion of a roller bearing. Due to the improved serviceability of the grounding contact, it can make sense to also use the grounding contact on a highly loaded or heavy-duty electric machine.

It is also preferable that the grounding contact is axially disconnectable between the first side and the second side. One of the two sides can be captively connected to the closure element. The disconnection can be carried out, in particular, without the use of tools. The first side and the second side can be held against one another via abutment, and one of the sides can be withdrawn once the closure element has been removed from the housing. This side can be designed as a wear element, enabling the wear element of the grounding contact to be easily inspected or replaced. The other side of the grounding contact can remain in the housing.

It is further preferred when the closure element is held in the recess by a thread. More preferably, the thread extends coaxially with the rotational axis. Preferably, an internal thread is provided in the recess and an external thread is provided on the closure element. In this way, the closure element can be securely held on the housing and easily removed if necessary. The thread allows for axial contact pressure between an external portion of the closure element and the housing. In this region, for example, a gasket can be inserted in order to prevent leakage of a fluid accommodated in the housing. In another example embodiment, an axial or radial annular groove can be provided on the closure element, into which annular groove an O-ring can be placed, the O-ring sealing the closure element with respect to the housing.

It is further preferred when an axial connecting element is provided between the closure element and the grounding contact. The grounding bearing can thus be arranged at a greater axial distance from the housing. This can be electrically or mechanically more favorable and the connecting element can be provided with a further purpose, in particular that of guiding a fluid in an axial direction, as is described in greater detail further below.

Preferably, the connecting element is attached to the closure element with clearance fit. In one preferred example embodiment, the connecting element is removably attached to the closure element. It is further preferred when the connecting element is non-rotatably held on the closure element. In this case, a rotational position can be established by an interlocking connection. A torque which is transmitted via the grounding contact despite the decoupling can be supported with respect to the closure element, or the housing, in this way. For example, a radial projection can be formed on the connecting element and a radial receptacle for the projection can be formed on the closure element. This connection can permit axial play between the connecting element and the closure element.

It is further preferred when the connecting element has an axial bore, and the closure element has a fluid duct, through which a fluid can enter in a radial direction and exit in an axial direction toward the bore. A fluid line can be provided on the housing, through which fluid can flow towards a radial end of the fluid duct. The fluid line can be attached to the housing or formed in a housing component. An annular duct can be provided between the fluid line and the fluid duct in order to compensate for a rotary alignment of the closure element with respect to the housing. The fluid can be provided for cooling and/or lubricating the electric machine. Preferably, the fluid includes a liquid, in particular oil.

The rotor of the electric machine preferably has a coaxial bore, into which the connecting element extends. The connecting element can have at least one radial recess in order to dispense fluid from the bore radially onto the rotor. As a result, the rotor can be supplied with fluid at any axial point in order to be lubricated or cooled. Fluid emerging from the radial recess can drain in an axial direction in a region between the connecting element and the rotor.

A conveyance of fluid after the fluid emerges from the connecting element can increase with a rotational speed of the rotor. A fluid barrier can be provided between the connecting element and the rotor in order to reduce a flow of fluid towards the closure element. The fluid barrier preferably lies between the closure element and a radial recess. As a result, the flow of fluid towards the grounding contact can be facilitated.

In a further example embodiment, an elastic element is provided in order to effect an axial force between the closure element and the connecting element. The elastic element can include, for example, a wave spring. The connecting element can be accommodated in a roller bearing in the region of the grounding contact in order to radially support the grounding contact. The roller bearing can be axially preloaded by the elastic element in order to ensure favorable support.

According to another example aspect of the present invention, a grounding device for an electric machine is provided. The electric machine has a housing and a rotor, which is mounted in the housing for rotation about a rotational axis. The housing has a recess at one axial end of the rotor. The grounding device has a closure element, which is designed to be removably attached in the recess; and a grounding contact, which is attached axially between the closure element and the rotor.

An electric drive axle has an electric machine described herein. The electric drive axle can also have a transmission. In one example embodiment, the drive axle is designed to be connected to a further drive motor, in particular an internal combustion engine. Torques of the electric machine or of the other drive motor can be provided at the output shaft.

According to a further example aspect of the present invention, a motor vehicle has an electric drive axle described herein.

### BRIEF DESCRIPTION OF THE DRAWINGS

Example aspects of the invention will now be described in greater detail with reference to the attached figures, in which:

FIG. 1 shows an electrically propelled motor vehicle;

FIG. 2 shows a grounding device on an electric machine; and

FIG. 3 shows a grounding device from a further perspective.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

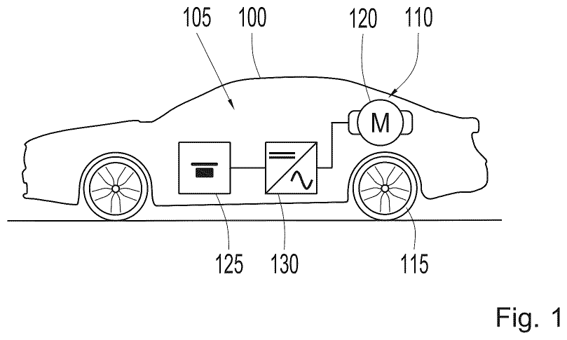

FIG. 1 shows a motor vehicle 100 with an electrical drive 105. The electrical drive 105 has an electric drive axle 110, which acts on a driving wheel 115 of the motor vehicle 100. The drive axle 110 has an electric machine 120, which can be operated by electrical energy from an energy store 125. A current transformer 130 is provided for converting DC voltage, which is usually provided by the energy store 125, into one or more AC voltages.

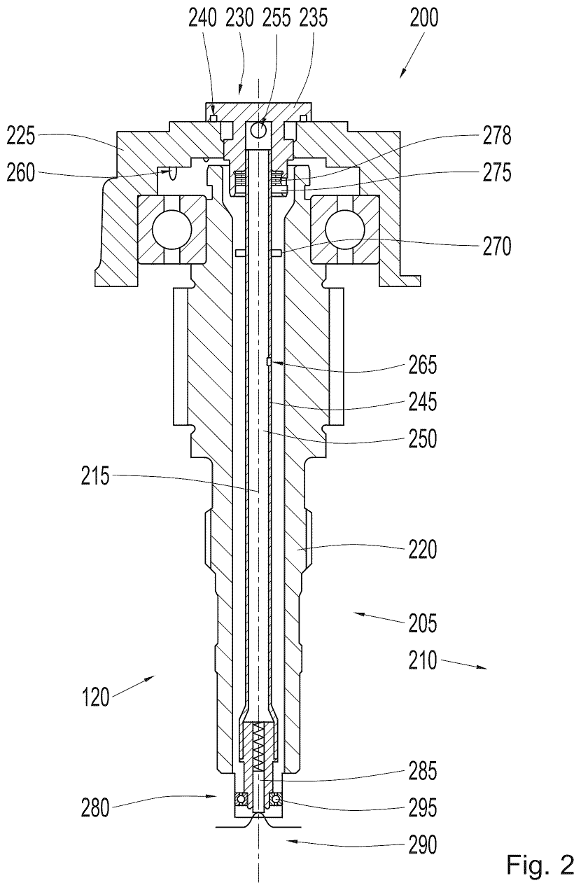

FIG. 2 shows a grounding device 200 on an electric machine 120. The electric machine 120 has a rotor 205 and a stator 210, which are mounted in such a way that the rotor 205 and stator 210 can rotate in relation to one another with respect to a rotational axis 215. Of the rotor 205, only a rotor shaft 220 is shown in FIG. 2. The stator 210 is rotationally fixed relative to a housing 225 and is not shown in FIG. 2.

A recess 230 is provided in the housing 225 coaxially with the rotational axis 215. A closure element 235 is arranged in the recess 230. Preferably, the recess 230 is round and has an internal thread; the closure element 235 has a corresponding external thread. A seal 240 can be provided between the closure element 235 and the housing 225. In the example embodiment shown, a contact surface, which runs perpendicularly to the rotational axis 215, is formed on an outer side of the housing 225. The closure element 235 has a collar, which projects over the contact surface. An axial groove which extends around the rotational axis 215 is introduced into the collar, into which axial groove an O-ring, as a seal 240, can be placed.

An axial end of a connecting element 245 is accommodated in the closure element 235. The connecting element 245 is preferably hollow and has an axial bore 250. It is further preferred when the connecting element 245 is formed in the manner of a tube. The closure element 235 has a fluid duct 255, which preferably enters the closure element 235 radially and emerges axially towards the connecting element 245. A fluid line 260 can be provided in or on the housing 225, through which, for example, a flow of oil towards the closure element 235 can be effected during operation of the electric machine 120. The oil can flow out of the fluid line 260 through the fluid duct 255 and into the bore 250 of the connecting element 245. The fluid can emerge at an end of the connecting element 245 remote from the closure element 235.

A radial recess 265 can be provided in the connecting element 245, through which fluid can enter a space radially between the connecting element 245 and the rotor shaft 220. In order to control a flow of fluid out of this space and, in particular, to facilitate an outflow axially towards the grounding contact 280, a fluid barrier 270 can be provided in an axial region between the recess 265 and the closure element 235. The fluid can cool the rotor shaft 220 radially from the inside.

In order to connect the connecting element 245 to the closure element 235 in a torque-transmitting manner, the connecting element 245 can have a radial projection 275, which engages into a corresponding recess in the closure element 235. Furthermore, an elastic element 278 can be provided, which acts axially between the connecting element 245 and the closure element 235. In the example embodiment shown, the elastic element 278 is supported axially against the projection 275 on the connecting element 245. In the present case, the elastic element 278 is formed from one or more wave springs, which extend around the connecting element 245.

At an axial end remote from the closure element 235, the connecting element 245 has a grounding contact 280 with a first side 285 and a second side 290. The second side 290 is electrically and mechanically formed on the rotor 205 or is connected thereto. The second side 290 is preferably made of a wear-resistant material such as steel. It is further preferred when the first side 285 is formed as a wear part, in particular in the form of an electrical brush having a carbon pin, which is electrically connected to the connecting element 245 by a flexible strand. The carbon pin can be pressed against the first side 285 by a coaxial elastic element, which is in the form of a cylindrical spring by way of example in this case. A predetermined portion of fluid accommodated in a space between the hollow rotor shaft and the connecting element 245 can flow through the grounding contact 280 and thus reduce wear. A usually substantially larger portion of the volumetric flow of fluid can emerge axially and be slung off at the rotor 205. Alternatively, the fluid can be accommodated in a fluid duct, which can conduct the fluid to a cooling or lubricating point, for example, a bearing of the rotor shaft 220 with respect to the stator 210, or the housing 225.

It is further preferred when a roller bearing 295 is provided in this region in order to radially support the first side 285 of the grounding contact 280, or an end of the connecting element 245 remote from the closure element 235. The roller bearing 295 can be axially preloaded by the elastic element 278 in the region of the closure element 235. As a result, the roller bearing 295 can be operated in an O-arrangement, which is advantageous for position control of the connecting element 245. Due to the elasticity of the element 278, a thermally induced change in length of the connecting element 245 can be compensated for.

If the closure element 235 is removed from the recess 230 in the housing 225, the connecting element 245 can be removed together with the first side 285 of the grounding contact 280. In this way, the grounding contact 280 can be easily inspected and replaced. For this purpose, in particular, the wear part of the first side 285 can be replaced. Thereafter, the first side 285 can be introduced, together with the connecting element 245, through the recess 230 in the housing 225 and secured thereon by the closure element 235.

The grounding device 200 shown can meet a mechanical, electrical and/or hydraulic requirement in an improved way. Advantageously, the grounding device 200 can simplify an inspection or maintenance and, in particular, allow the grounding contact to be replaced, without a housing 225 being removed.

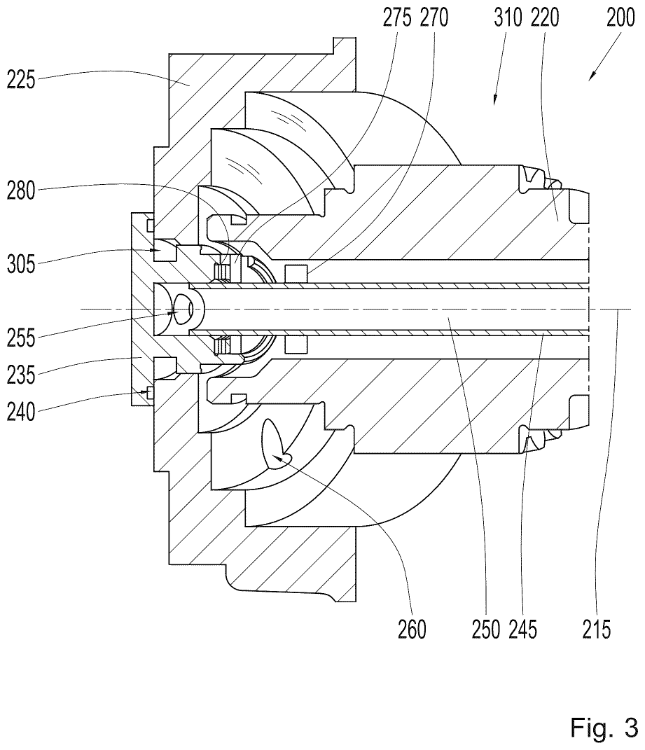

FIG. 3 shows a grounding device 200 of the type shown in FIG. 2 from a further perspective. The rotational axis 215 is inclined with respect to the plane of the drawing. At its right end, the rotational axis 215 extends toward the observer.

It is apparent that an annular duct 305 is formed between the fluid line 260 and the fluid duct 255. The fluid line 260 is part of the housing 225 in this case, but can also be formed as a separate element. The fluid line 260 ends in the annular duct 305 and, there, an inlet of the fluid duct 255 begins. Due to the annular duct 305, the closure element 225 can be aligned in any way about the rotational axis 215 in order to allow fluid from the fluid line 260 to pass into the fluid duct 255.

The portion of the housing 225 shown can include, for example, a housing cover, which can be formed, for example, from cast light metal.

In a right region of the schematic view, the rotor shaft 220 has a tooth system 310 for engaging into a gear wheel of a transmission. The tooth system 310 is preferably in the form of helical toothing and can act on the driving wheel 115 via the transmission.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

100 motor vehicle
105 electrical drive
110 electric drive axle
115 driving wheel
120 electric machine
125 energy store
130 current transformer
200 grounding device
205 rotor
210 stator
215 rotational axis
220 rotor shaft
225 housing
230 recess
235 closure element
240 seal
245 connecting element
250 bore
255 fluid duct
260 fluid line
265 recess
270 fluid barrier
275 projection
278 elastic element
280 grounding contact
285 first side
290 second side
295 roller bearing
305 annular duct
310 tooth system

1-13: (canceled)

14. An electric machine (120), comprising:
a housing (225) comprising a recess (230); and
a rotor (205) mounted in the housing (225) for rotation about a rotational axis (215), the recess (230) disposed at one axial end of the rotor (205);
a closure element (235) removably attached in the recess (230); and
a grounding contact (280) arranged axially between the closure element (235) and the rotor (205).

15. The machine (120) of claim 14, wherein the grounding contact (280) comprises a first side (285) and a second side (290), the first and second sides (285, 290) of the grounding contact (280) electrically connected together and separate from each other with respect to a torque.

16. The machine (120) of claim 15, wherein the grounding contact (280) is axially disconnectable between the first side (285) and the second side (290).

17. The machine (120) of claim 14, wherein the closure element (235) is mounted in the recess (230) by a thread.

18. The machine (120) of claim 14, further comprising an axial connecting element (245) between the closure element (235) and the grounding contact (280).

19. The machine (120) of claim 18, wherein the connecting element (245) is non-rotatably attached to the closure element (235).

20. The machine (120) of claim 18, wherein:
the connecting element (245) comprises an axial bore (250);
the closure element (235) comprises a fluid duct (255), and
a fluid is flowable into the fluid duct (255) in a radial direction and flowable out of the fluid duct (255) in an axial direction toward the axial bore (250).

21. The machine (120) of claim 20, wherein:
the rotor (205) comprises a coaxial bore;
the connecting element (245) extending into the coaxial bore; and
the connecting element (245) comprises at least one radial recess (265) for radially dispensing fluid from the bore (250).

22. The machine (12) of claim 21, further comprising a fluid barrier (270) disposed between the connecting element (245) and the rotor (205) in order to reduce a flow of fluid towards the closure element (235).

23. The machine (120) of claim 18, further comprising an elastic element (278) disposed such that the elastic element (278) provides an axial force between the closure element (235) and the connecting element (245).

24. A grounding device (200) for an electric machine (120) that includes a housing (225) and a rotor (205) mounted in the housing (225) for rotation about a rotational axis (215), the housing (225) including a recess (230) at one axial end of the rotor (205), the grounding device (200) comprising:
a closure element (235) configured to be removably attached in the recess (230); and
a grounding contact (280) configured to be attached axially between the closure element (235) and the rotor (205).

25. An electric drive axle (110), comprising the electric machine (120) of claim 14.

26. A motor vehicle (100), comprising the electric drive axle (110) of claim 25.
